(19) United States
(12) Patent Application Publication
(10) Pub. No.: US 2004/0186871 A1
(43) Pub. Date: Sep. 23, 2004

(54) Multiplier circuit

(76) Inventors: Donato Ettorre, Torino (IT); Bruno Melis, Torino (IT); Alfredo Ruscitto, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/487,109

(22) PCT Filed: Aug. 14, 2002
(86) PCT No.: PCT/IT02/00540

(30) Foreign Application Priority Data
Aug. 17, 2001 (IT) TO2001 A000817

(51) Int. Cl. G06F 7/52

(52) U.S. Cl. 708/620

(57) ABSTRACT

An iterative multiplier circuit (10) comprises modules (15 to 18) that subdivide the respective input signals (Zₙ, Jₙ) into a first part (msb(Zₙ), msb(Jₙ)) that is the power of 2 immediately lower or equal to the input signal and a second part (Zₙ—msb(Zₙ), Jₙ—msb(Jⁿ)) corresponding to the difference between the input signal and the aforesaid first part. A shift module (19) generates a respective output signal through shift operations that implement the multiplication operation for numbers that are powers of 2. The circuit operates according to a general iterative scheme in which at each step three components of the output signal (X,Y) are computed, corresponding to the product of two numbers that are powers of 2 and to two products in which at least one of the factors is a power of 2. The number of steps in the iteration scheme is controllable, thus allowing to vary the accuracy with which the output value (X,Y) is calculated.

### TECHNICAL FIELD

The present invention relates to multiplier circuits.

### BACKGROUND ART

Fast multiplier circuits, able to exploit in efficient fashion the semiconductor area whereon they are integrated, constitute essential blocks for the digital signal processing systems.

For instance, in the telecommunications industry there are many circuits (numerical filters, automatic frequency control devices, equalisers, various compensation circuits, etc.) that require to perform the fast multiplication of pairs of numerical values.

In this regard, reference can usefully be made to the well known volume by J. G. Proakis, “Digital Communications”, 3rd edition, McGraw-Hill, 1995.

In such applications, the multipliers must be sufficiently small to be integrated in high numbers even on a small chip. In addition to speed and size (occupied area), another factor to be considered is given by the precision or accuracy of the result obtained, as there are many applications that require only a broad accuracy and not the absolute determination of the exact value of the product.

Prior art multiplier circuit solutions have, to a lesser or greater extent, a rigidity of configuration and operation. In particular, such prior art solutions are not easy to programme in terms of required precision or accuracy and do not allow—for example—to “exchange” the degree of required accuracy and/or occupied area with computing time.

In this regard it should further be noted that, at least in some applications, a particularly fast multiplier circuit can actually be revealed to be—given its considerable occupied area—a widely unused resource. This is because, after rapidly performing its function, the multiplier circuit is then forced to wait (giving rise to idle time) the completion of processing operations performed more slowly by other circuits whereto the multiplier is associated.

### DISCLOSURE OF THE INVENTION

The aim of the present invention is to provide a multiplier circuit that is able to overcome the intrinsic drawbacks of the prior art solution.

According to the present invention said aim is achieved thanks to a multiplier circuit having the characteristics specifically described in the claims that follow.

The solution according to the invention allows to obtain such an iterative multiplier circuit as to allow a considerable reduction in terms of occupied area relative to other prior art array multiplier solutions.

In the prior art, various types of iterative multiplier circuits are known which base their operation on the so-called modified Booth algorithm: in this regard, reference can usefully be made to the documents US-A-5 220 525, EP-A-0 497 622, EP-A-0 825 523 e WO-A-00/59112.

With respect to said prior art solutions, the circuit according to the invention offers—among others—the advantage of being completely programmable in terms of precision of the final result obtained.

In particular, precision can be modified during operation simply by changing the maximum number of iterations, parameter that can be control externally, for example, by means of a DSP (Digital Signal Processor).

This advantage is shared by the solution according to the invention with a power raising circuit described in a patent application for industrial invention filed on the same date by the same Applicant.

### BRIEF DESCRIPTION OF DRAWINGS

The invention shall now be described, purely by way of non limiting example, with reference to the accompanying drawings, in which:

FIGS. 1 e 2 are destined to illustrate in geometric terms the theoretical principles whereon the invention is based,

FIG. 3 shows, in the form of a block diagram, the structure of a multiplier circuit according to the invention,

FIG. 4 shows the possible criteria for realising one of the modules shown in the block diagram of FIG. 3, and

FIG. 5 is a flow chart showing the operation of the circuit illustrated in FIG. 3.

### BEST MODE FOR CARRYING OUT THE INVENTION

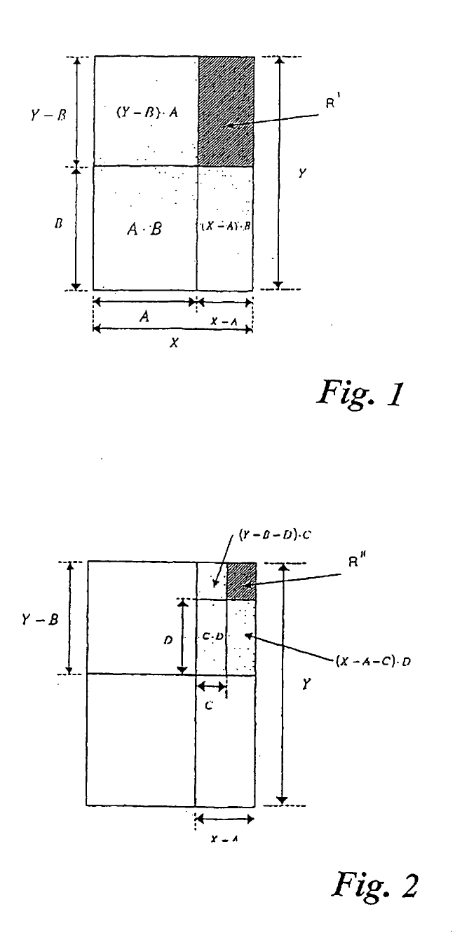

It seems useful to start by illustrating, with reference to FIGS. 1 and 2, the (geometric) principle whereon the operation of the multiplier circuit according to the invention is based.

Referring first to FIG. 1, it is presumed that X and Y represent the two factors of the multiplication operation to be performed.

As normally occurs in digital signal processing circuits, the two factors in question are represented by respective binary signals, i.e. by a string of bits that take on the value “0” or “1”.

It will also be presumed that X and Y are any positive numbers, the handling of a possible sign of the two factors being easily able to be performed with distinct circuits, known in themselves.

The product X·Y therefore represents the area of the rectangle shown in FIG. 1.

Let it be supposed then that A and B are the two numbers constituting the powers of 2 immediately lower or equal with respect to X and with respect to Y, i.e., according to a current notation with reference to the binary numbers A=msb(X) and B=msb(Y) wherein msb stays for most significant bit.

Observing FIG. 1, it is readily apparent that the value of the product X·Y can be approximated by the value:

S₁=A·B+B·(X−A)+A·(Y−B)

The approximate value S₁ corresponds to the sum of a first, a second and a third portion of area respectively corresponding:

to the area A·B of the rectangle reproduced in the lower left side of FIG. 1,

to the area B·(X−A) of the bottom right rectangle, and

to the area A·(Y−B) of the top left rectangle.

The area of the rectangle R′ shown as a dashed area at top right constitutes the approximation error whose value is equal to the product (X−A)·(Y−B) (observe FIG. 1 for the immediate comprehension of the geometric meaning of the above statement).

The value of this error (i.e., in practice the area of the rectangle R′ represented in FIG. 1) can, in turn, be approximated in the form of the following product:

S₂=C·D+D·(X−A−C)+C·(Y−B−D)

In this case, too, the geometric meaning of the approximation is immediately understandable in geometric terms, referring to the representation of FIG. 2.

In this case, the values C and D are identified as the powers of 2 immediately lower than (X−A) and with respect to (Y−B), i.e. C=msb (X−A) and D=msb (Y−B).

In this case, too, there is a remaining error corresponding to the area of the rectangle R″ represented in the top right corner of FIG. 2.

However, it is readily understandable that the described procedure can be iterated M times—with M=log₂(max(X,Y)−1), where max (X,Y) represents the maximum of the distributions of the possible input values of X and Y—thereby obtaining the exact value of the product according to the expression:

X−Y=S₁+S₂+ . . . +S_{M}

Naturally, the one shown in FIGS. 1 and 2 (and in the subsequent steps through to step M conceptually derivable in 10 obvious fashion from the representation of FIGS. 1 and 2) corresponds to the most general step that can be hypothesised. There are pairs of X and Y values in which the residual approximation error is ascribable to only one of the multiplication factors and not to both factors as in the case of the geometric representations 1 and 2.

In this regard it should be noted that the dichotomous method represented in the Figures of the accompanying drawings and applied to both factors X and Y can actually be applied also to only one thereof.

Similarly, the method according to the invention can—at least virtually—be applied also to a product of three or more factors.

The invention is based on the recognition of the fact that the product of factors i) that are both powers of 2 (for example, the products A B and C D) or ii) whereof at least one is a power of 2 (for example the products A (Y−B) or B−(X−A)) is easily achievable by means of simple shift operations carried out on one of the factors—whether or not it is a power of 2—as a function of the exponent that expresses the other factor as a power of 2.

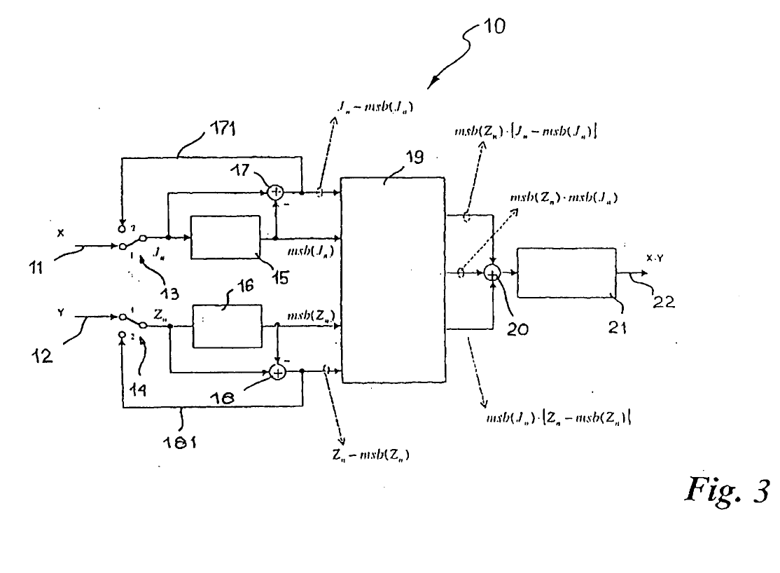

In the diagram of FIG. 3, the numerical reference 10 globally indicates a multiplier circuit according to the invention.

The two factors of the multiplication X and Y are applied as digital values respectively on the inputs indicated as 11 and 12.

The references 13 and 14 indicate two switches that during the first step of the iterative multiplication process are in the position indicated as 1. The switches 13 and 14 then move to the position indicated as 2 during the subsequent steps of the iterative process of refining the final result.

The references 15 and 16 indicate two modules (possibly replaceable with a single module made to function according to a time multiplex scheme) destined to co-operate with respective summation nodes 17 and 18 to subdivide the respective input signal Zₙ, Jₙ into a first part msb(Zₙ), msb(Jₙ) that is the power of 2 immediately lower than Zₙ and Jₙ—respectively—and a second part corresponding to the difference between the respective input signal and the aforesaid first part, i.e. Zₙ—msb(Zₙ) and Jₙ—msb(Jₙ), respectively.

In the remainder of the present description, the symbol J shall indicate the signals deriving from the signal X and the symbol Z the signals deriving from the signal Y. The subscript n shall instead indicate the generic step of the iterative multiplication process.

The modules 15 and 16 are circuits that determine the aforesaid first signal part extracting the most significant bit (msb) of the binary strings brought to their input and masking (i.e. setting to zero) the subsequent bits.

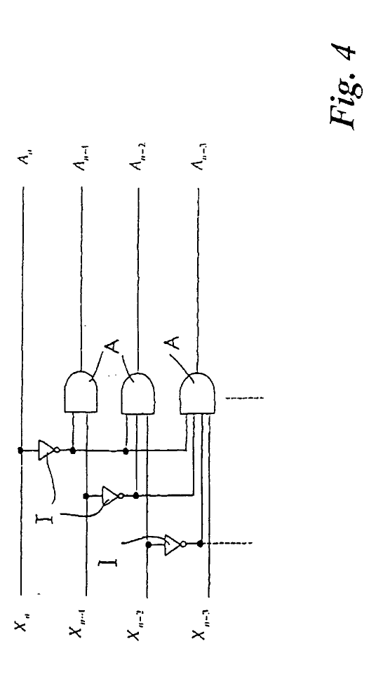

A possible corresponding circuit diagram is shown in FIG. 4, where the references I and A respectively indicate logic inverters and logic gates of the AND type. The symbols Xₙ, Xₙ₋₁, Xₙ₋₂, . . . e Aₙ, Aₙ₋₁, Aₙ₋₂, . . . indicate, starting from the most significant bit, the bits of the input signal and of the output signal of the module 15 or 16.

The two summation nodes 17 and 18 receive at their input the signals present at the input (with positive signs) and at the output (with negative sign) of the module, 15 or 16, whereto the summation node is respectively associated. At the output of the summation nodes 17 and 18, therefore, the aforesaid second part of signal is present.

Since msb(Zₙ) and msb(Jₙ) are the powers of 2 immediately lower or equal to Zₙ and Jₙ, their value is expressed by a binary string containing a single bit at “1”. The aforesaid second part of signal can thus be determined in a simple manner through a combinatory network with elementary structure.

The reference 19 indicates a programmable shifter module that receives as inputs the output signals from the modules 15 and 16 and from the summation nodes 17 and 18.

At the output of the module 19 there is an additional summation node 20 that in turn feeds a summation and accumulation module 21, destined to provide at its output the value (approximate or exact, depending on the number of iterations carried out) of the X·Y product. The corresponding signal produced is presented on an output line indicated as 22.

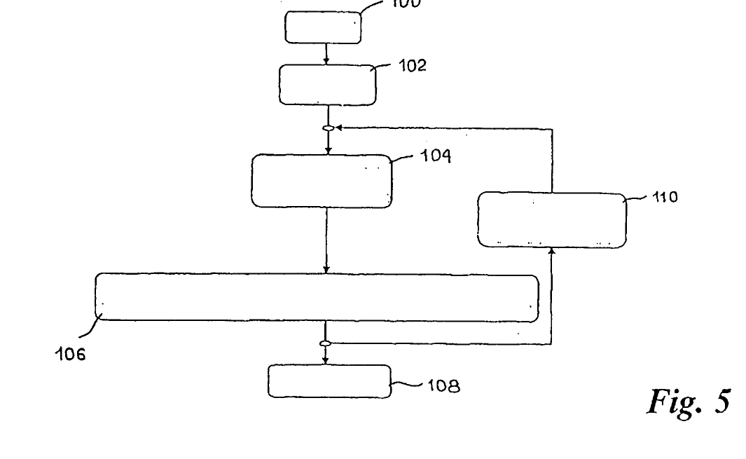

The operation of the circuit of FIG. 3 can be understood referring to the flow chart of FIG. 5 and to the indications provided on the signal propagation paths shown in FIG. 3.

In the initial operating step (step 100 in the diagram of FIG. 5) the two factors X and Y are brought to the input of the circuit on the lines 11 and 12. The switches 13 and 14 are in the position indicated as 1, so that the values X and Y are fed (step 102) to the input of the circuits 15 and 16 that compute in their first iteration of a step indicated as 104 the values A=msb (X) and B=msb (Y): in this regard, see FIG. 1.

Still proceeding with the first step of the iterative multiplication process, during a subsequent step indicated as 106, the set of the summation nodes 17 and 18 and of the shifter module 19 calculates the value S₁=A·B+B·(X−A)+A·(X−B). Said value is accumulated in the module 21 in a step indicated as 108.

Simultaneously, in a step indicated as 110, the two signals X−A and Y−B present on the outputs of the summation nodes 17 and 18 (factors that identify the residual error, i.e. the are of the rectangle R′ in FIG. 1) are sent back, through respective recycling lines 171 and 181, towards the switches 13 and 14 that have moved to the position indicated as 2.

The successive steps of the iterative calculation process are thus started.

At the n-th iteration, the process provides for using as input signals towards the modules 15 and 16 the signals:

Jₙ=Jₙ₋₁−msb(Jₙ₋₁)

and

Zₙ=Zₙ₋₁−msb(Zₙ₋₁)

Similarly, the set of summation nodes 17 and 18, of the shifter circuit 19 and of the node 20 calculates the value

Sₙ=msb(Zₙ)·msb(Jₙ)+msb(Zₙ)·[Jₙ−msb(Jₙ)]+msb(Jₙ)·[Zₙ−msb(Zₙ)]

In this regard, it will be appreciated that the operations performed in the summation nodes 17 and 18 simply correspond to the cancellation of determined bits in the representative string of the signal Zₙ and Jₙ, whilst the operations performed in the module 19 correspond solely to bit shifts by a determined number of positions.

As stated previously, the number of steps to perform in the iterative calculation process can be imposed selectively from outside the circuit 10, for instance by means of a control device or circuit such as a DSP, also under run time conditions.

Upon obtaining the final (exact or approximate) result, the circuit 10 is reset in view of the feeding of a new pair of input values X and Y, bringing the switches 13 and 14 back to the position indicated as 1 and zeroing the content of the module 21.

It is also possible to command the circuit 10 in such a way as to provide for no iteration, so that the circuit 10 only provides at the output on the line 23 the approximation of the product X·Y given by the factor S₁ calculated directly starting from the input data X and Y brought on the lines 11 and 12 without the switches 13 and 14 moving to the position indicated as 2 to perform additional steps for refining the result.

This occurs according to criteria readily available to the person skilled in the art, which therefore require no detailed description herein. This also holds in regard to the possible presence, at the input of the circuit 10, of elements able to recognised particular values of one or both the factors X and Y and such as to allow or bypass or skip one or more steps of the described operating method.

Naturally, without changing the principle of the invention, the realisation details and the embodiments may be amply varied relative to what is described and illustrated herein, without thereby departing from the scope of the present invention.

1. Multiplier circuit (10) for generating, starting from at least a first (X) and a second (Y) binary digital signal representative of respective factors to be multiplied each other, an output signal (X-Y) representative of the product of said factors, characterised in that it comprises:
at least one extracting powers of 2 module (15 through 18) able to subdivide a respective input signal (Zₙ, Jₙ) into a first part (msb(Zₙ), msb(Jₙ)) that is the power of 2 immediately lower or equal to said respective input signal (Zₙ, Jₙ) and a second part (Zₙ−msb(Zₙ), Jₙ−msb(Jₙ)) corresponding to the difference between said respective input signal and said first part,
an input module (13, 14) for applying at least one (X or Y) of said first and second binary digital signal as said respective input signal to said at least one extracting module (15 through 18), and
a shifter module (19) co-operating with said at least one extracting module (15 through 18) for generating at least one first portion of said output signal (X·Y) by means of a shift operation performed on the other (Y or X) between said first and second binary digital signal by a number of positions identified by the first part of said one between said first (X) and second (Y) binary digital signal generated by said extracting module (15 through 18).

2. Multiplier circuit as claimed in claim 1, characterised in that:
said input module (13, 14) is configured to apply both said first (X) and said second (Y) binary digital signal as an input signal to said at least one extracting module (15 through 18), so that said extracting module (15 through 18) is able to generate said first part (A, B) and said second part (X−A, Y−B) for said at least first (X) and second (Y) binary digital signals (X, Y), and
said shifter module is configured to generate, by means of shift operations, at least a first, a second and a third portion of said output signal (X·Y) respectively corresponding:
to the product (A·B) of the first part (A) of said first binary digital signal and of the first part (B) of said second binary digital signal (Y),
to the product of the first part (B) of said second binary digital signal (Y) with the second part (X−A) of said first binary digital signal (X), and
to the product of the first part (A) of said first binary digital signal (X) with the second part (Y−B) of said second binary digital signal (Y).

3. Circuit as claimed in claim 1 or claim 2, characterised in that said input module (13, 14) has associated at least a return path (171, 181) to bring back to the input of said at least one extracting module (15 through 18), according to an iterative scheme comprising a set of subsequent steps, said second part generated in a previous step of said iterative scheme as respective input signal (Zₙ, Jₙ) to be used in a further step of said iterative scheme, and
said shifter module (19) has associated an accumulation element (21) for iteratively accumulating said at least one first portion of said output signal generated by said shifter module (19) in the subsequent steps of said iterative scheme.

4. Circuit as claimed in claim 2 and claim 3, characterised in that in each of said subsequent steps of said iterative scheme, said shifter module (19) generates a first, a second and a third portion of said output signal (X·Y) accumulated in said accumulation element (21) and respectively corresponding:
to the product (msb(Zₙ)·msb(Jₙ)) of two respective first parts generated by said at least one extracting module (15 through 18) starting respectively from said first (X) and said second (Y) binary digital signal,
to the product (msb(Zₙ)·((Jₙ)−msb(Jₙ))) of a first part of signal generated by said at least one extracting module (15 through 18) starting from said first binary digital signal (X) with a second part of signal generated by said at least one extracting module (15, 16) starting from said second binary digital signal (Y), and
to the product (msb(Jₙ)·((Zₙ)−msb(Zₙ))) of a first part of signal generated by said at least one extracting module (15 through 18) starting from said second binary digital signal (Y) with a second part of signal generated by said at least one extracting module (15 through 18) starting from said first binary digital signal (X).

5. Circuit as claimed in claim 3 or claim 4, characterised by a control circuit for selectively controlling the number of the steps of said iterative scheme.

6. Circuit as claimed in any of the previous claims, characterised in that said at least one extracting module comprises:
a unit (15, 16) for receiving said respective input signal (Zₙ, Jₙ) and generating from there as respective output signal (msb(Zₙ), msb(Jₙ)) said first part of signal that is the power of 2 lower than or equal to said respective input signal, and
a summation node (17, 18) that receives with opposite signs said respective input signal (Zₙ, Jₙ) and said respective output signal (msb(Zₙ), msb(Jₙ)) and determines from them said second part of signal (Zₙ−msb(Zₙ), Jₙ−msb(Jₙ)).

7. Method for generating, starting from at least a first (X) and a second (Y) binary digital signal representative of respective factors to be multiplied each other, an output signal (X·Y) representative of the product of said factors, characterised by the steps of:
extracting (15 through 18) from said at least first or second binary digital signal representative of a respective input signal (Zₙ, Jₙ) a first part (msb(Zₙ), msb(Jₙ)) that is the power of 2 immediately lower or equal to said respective input signal (Zₙ, Jₙ) and a second part (Zₙ−msb(Zₙ), Jₙ−msb(Jₙ)) corresponding to the difference between said respective input signal and said first part, and
generating at least a first portion of said output signal (X·Y) by means of a shift operation performed on the other (Y or X) between said first and second binary digital signal by a number of positions identified by the first part of said one between said first (X) and second (Y) binary digital signal.

8. Method as claimed in claim 7, characterised by the step of:
generating, by means of shift operations, at least a first, a second and a third portion of said output signal (X·Y) respectively corresponding:
to the product (A·B) of the first part (A) of said first binary digital signal (X) and of the first part (B) of said second binary digital signal (Y),
to the product of the first part (B) of said second binary digital signal (Y) with the second part (X−A) of said first binary digital signal (X), and
to the product of the first part (A) of said first binary digital signal (X) with the second part (Y−B) of said second binary digital signal (Y).

9. Method as claimed in claim 7 or claim 8, characterised by an iterative scheme comprising the steps of
bringing back said second part generated in a previous step as respective new input signal (Zₙ, Jₙ) to be used in a further step of said iterative scheme as new input signal,
extracting (15 through 18) from said respective new input signal (Zₙ, Jₙ) a new respective first part (msb(Zₙ), msb(Jₙ)) that is the power of 2 immediately lower or equal to said new input signal (Zₙ, Jₙ) and a new second part (Zₙ−msb(Zₙ), Jₙ−msb(Jₙ)) corresponding to the difference between said new input signal and said new first part,
generating at least one new first portion of said output signal (X·Y) by means of a shift operation performed on said respective new input signal (Zₙ, Jₙ), and
accumulating said at least one new first portion of said output signal in the subsequent steps of said iterative scheme.

10. Method according to claim 9, characterised by the step of
selectively controlling the number of the steps of said iterative scheme.
